(19) United States
(12) Patent Application Publication
(10) Pub. No.: US 2006/0058931 A1
(43) Pub. Date: Mar. 16, 2006

(54) Collision avoidance involving radar feedback

(75) Inventors: Kartik B. Ariyur, Minnetonka, MN (US); Dale F. Enns, Roseville, MN (US); Peter Lommel, Cambridge, MA (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., MORRISTOWN, NJ (US)

(21) Appl. No.: 10/941,535

(22) Filed: Sep. 15, 2004

(51) Int. Cl. G05D 1/00

(52) U.S. Cl. 701/23; 701/301

(57) ABSTRACT

Collision avoidance systems and methods are implemented on unmanned mobile vehicles to supplement map-based trajectories generated by the vehicles' navigation systems. These systems include radar, which detect obstacles in the path of the unmanned mobile vehicles, and collision avoidance modules, which enable the vehicles to avoid unexpected obstacles by adjusting their trajectories and velocities based on feedback received from the radar. In general, when an obstacle is detected by the radar, the collision avoidance module modifies the commanded velocity of an unmanned mobile vehicle by subtracting from the nominal commanded velocity the component that is in the direction of the obstacle. The magnitude of the velocity modification typically increases as the distance between the mobile vehicle and the obstacle decreases.

### TECHNICAL FIELD

This application relates in general to collision avoidance systems and, more specifically, to collision avoidance systems involving radar feedback.

### BACKGROUND

Unmanned mobile vehicles, such as, for example, unmanned aerial vehicles (UAVs) or mobile ground vehicles, are becoming more commonly used in a wide variety of applications. These vehicles are typically equipped with one or more sensors to monitor and collect data regarding the vehicle's surrounding environment. This data is often transmitted over one or more wireless data links to a human operator or a central data gathering station.

Unmanned mobile vehicles are also typically equipped with navigation systems to enable the vehicles to travel to their intended destinations. These navigation systems often generate optimal trajectories based on maps of the locations in which the vehicles are traveling. If the vehicles are operating at high altitudes or in other free-space environments in which there are virtually no obstructions, the vehicles can usually travel safely to their destinations relying solely upon map-based trajectories.

In many applications, however, it is desirable to use unmanned mobile vehicles in environments having complex terrain, such as, for example, urban environments with buildings and other obstructions, or natural environments with trees and other obstructions. In such complex environments, unmanned mobile vehicles cannot rely solely upon map-based trajectories, because the underlying maps often contain errors or insufficient information about the topography. In addition, unexpected obstacles may pop up while the vehicles are in transit.

Accordingly, there is a need for a reliable collision avoidance system that enables an unmanned mobile vehicle to make online adjustments to the map-based trajectories generated by its navigation system.

### SUMMARY OF THE INVENTION

The above-mentioned drawbacks associated with existing mobile vehicle systems are addressed by embodiments of the present invention and will be understood by reading and studying the following specification.

In one embodiment, an unmanned mobile vehicle comprises a radar configured to detect obstacles in the path of the unmanned mobile vehicle and a collision avoidance module configured to enable the unmanned mobile vehicle to avoid unexpected obstacles by adjusting the trajectory and velocity of the unmanned mobile vehicle based on feedback received from the radar.

In another embodiment, a method for avoiding an obstacle in an unmanned mobile vehicle comprises detecting the obstacle with a radar and, while the obstacle is within radar range, eliminating the component of the vehicle's velocity that is in the direction of the obstacle.

In another embodiment, a system comprises a plurality of unmanned mobile vehicles. Each unmanned mobile vehicle comprises a navigation system configured to generate map-based trajectories, a radar configured to detect obstacles in the path of the unmanned mobile vehicle, and a collision avoidance module configured to enable the unmanned mobile vehicle to avoid unexpected obstacles by adjusting the trajectory and velocity of the unmanned mobile vehicle based on feedback received from the radar.

The details of one or more embodiments of the claimed invention are set forth in the accompanying drawings and the description below. Other features and advantages will become apparent from the description, the drawings, and the claims.

### BRIEF DESCRIPTION OF THE DRAWINGS

FIG. 1 is a schematic of a mobile vehicle traveling toward a destination.

FIG. 2A is a schematic of the mobile vehicle illustrated in FIG. 1 after an obstacle enters the field of view of its radar.

FIG. 2B is a graph of a velocity modification gain term.

FIG. 3 is a schematic of a mobile vehicle implementing exemplary embodiments of a specific collision avoidance strategy.

Like reference numbers and designations in the various drawings indicate like elements.

### DETAILED DESCRIPTION OF THE PREFERRED EMBODIMENTS

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical, and electrical changes may be made without departing from the spirit and scope of the present invention. The following detailed description is, therefore, not to be taken in a limiting sense.

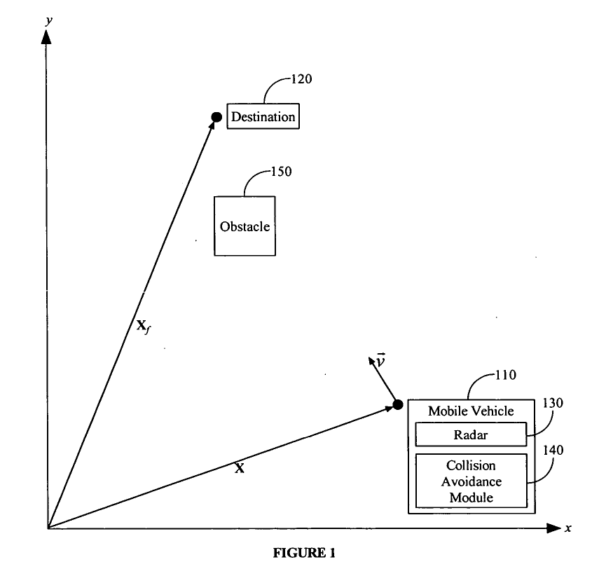

FIG. 1 is a schematic of a mobile vehicle 110 traveling toward a destination 120. In a preferred embodiment, the mobile vehicle 110 comprises a hover-capable UAV, such as, for example, an organic air vehicle (OAV). In other embodiments, however, the mobile vehicle 110 may comprise any of a wide variety of other unmanned mobile vehicles, such as, for example, fixed-wing UAVs, mobile ground vehicles, unmanned underwater vehicles (UUVs), or the like. In the illustrated embodiment, the mobile vehicle 110 comprises radar 130 and a collision avoidance module 140. Those of ordinary skill in the art will understand that the mobile vehicle 110 comprises numerous additional components, such as, for example, sensors, processors, communication devices, etc. which, for simplicity, are not shown in the illustrated embodiment.

In FIG. 1, a point mass model is used to represent the mobile vehicle 110. In some cases, the destination 120 is the vehicle's final destination, whereas in other cases, the destination 120 is an intermediate destination along the vehicle's route, such as a waypoint generated by the vehicle's navigation system. The current position of the mobile vehicle 110 is represented by the vector labeled X, and the position of its destination 120 is represented by the vector labeled X_{ƒ}. The current velocity of the mobile vehicle 110 is represented by the vector labeled \vec{ν}. While a two-dimensional example is illustrated for simplicity, a similar model can be used for situations in which the mobile vehicle 110 travels in three dimensions.

A conventional double integrator model, along with speed and acceleration limits, can be used to represent the tracking dynamics of the mobile vehicle 110, as is well-known to those of ordinary skill in the art. Standard control design techniques, such as dynamic inversion, make the tracking dynamics behave as a double integrator. For example, if attitude stabilization is designed through dynamic inversion, the tracking dynamics are reduced to a double integrator model, with speed and acceleration saturation limits. Using such a double integrator model, the following relationships are established:

$$\begin{matrix}\ddot{x} = {a}_{cmd} , where : \\ x = {[ x y ]}^{T} , and {a}_{cmd} = {[ {a}_{x} {a}_{y} ]}^{T} in 2 D ; or \\ x = {[ x y z ]}^{T} , and {a}_{cmd} = {[ {a}_{x} {a}_{y} {a}_{z} ]}^{T} in 3 D .\end{matrix}$$

The speed and acceleration limits of the mobile vehicle 110 are set forth in the following equations:
∥\vec{ν}∥≦νₘₐₓ, where \vec{ν}=\dot{x}; and
∥a_{cmd}∥≦αₘₐₓ.

In these equations, νₘₐₓ and αₘₐₓ represent the vehicle's maximum velocity and acceleration, respectively, which are determined based on a number of factors, such as vehicle mass and available power. The nominal closed loop control for stable tracking by the double integrator is governed by the following equations:

$${a}_{cmd} = \{ \begin{matrix}\frac{{\vec{v}}_{cmd} - \vec{v}}{{τ}_{v}} & ‖ \frac{{\vec{v}}_{cmd} - \vec{v}}{{τ}_{v}} ‖ \leq {a}_{max} \\ {a}_{max} \frac{\frac{{\vec{v}}_{cmd} - \vec{v}}{{τ}_{v}}}{‖ \frac{{\vec{v}}_{cmd} - \vec{v}}{{τ}_{v}} ‖} & ‖ \frac{{\vec{v}}_{cmd} - \vec{v}}{{τ}_{v}} ‖ > {a}_{max}\end{matrix} ; and \\ {\vec{v}}_{cmd}^{nom} = \frac{{X}_{f} - X}{{τ}_{x}} .$$

In these equations, the τ_{ν}and τₓ terms represent the velocity and position tracking time constants, respectively. The \vec{ν}_{cmd}^{nom} vector represents the vehicle's nominal commanded velocity, which is typically determined based on a map-based trajectory generated by the vehicle's navigation system. The \vec{ν}_{cmd} vector represents the vehicle's actual commanded velocity, which is related to the nominal commanded velocity but may differ from it to enable obstacle avoidance.

For example, as illustrated in FIG. 1, an obstacle 150, such as a building or a tree, is located between the mobile vehicle 110 and its destination 120. The obstacle 150 is unknown to the vehicle's navigation system because if the mobile vehicle 110 continues at its designated trajectory and velocity (selected by the navigation system), the mobile vehicle 110 will collide with the obstacle 150 before it can reach its destination 120. The obstacle 150 may be unexpected by the navigation system for a number of reasons. For example, the obstacle 150 may not be included in the maps used by the navigation system because they contain errors or because they lack sufficiently detailed topographical information, or a position-sensing component (e.g., GPS) of the navigation system may provide inaccurate information regarding the position of the mobile vehicle 110. The obstacle 150 may also be temporary in nature, such as, for example, a clothesline, an antenna, or a moving object. In the illustrated embodiment, the radar 130 and collision avoidance module 140 advantageously enable the mobile vehicle 110 to reach its destination 120 while avoiding a collision with the obstacle 150, as described in more detail below.

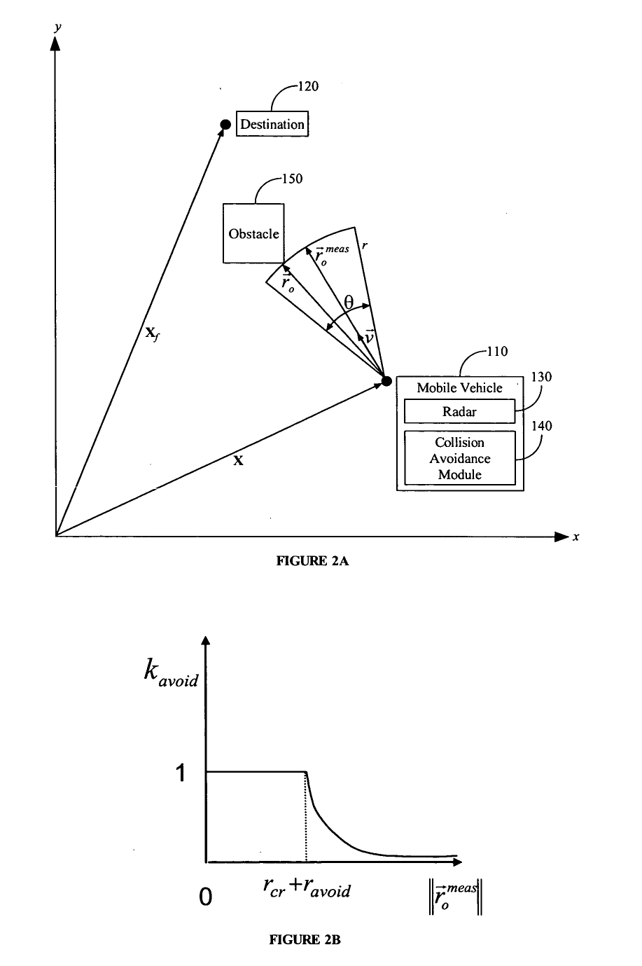

FIG. 2A is a schematic of the mobile vehicle 110 illustrated in FIG. 1 after the obstacle 150 enters the field of view of its radar 130. In some embodiments the radar 130 has a maximum range, rₘₐₓ, of about 50 feet or less and a view angle, θ, of about 40° or less with a (low) angular resolution of about 40°. Radars having these specifications are typically relatively lightweight and inexpensive. If these features are not critical in a given application, then a suitable radar having better resolution and field of view can be utilized. The radar 130 is typically fixed in orientation with respect to the mobile vehicle 110. For example, in some embodiments, the radar 130 points in the direction of motion of the mobile vehicle 110.

In some embodiments, when an obstacle is detected by the radar 130, the collision avoidance module 140 computes a modified command velocity using the following equation:

$${\vec{v}}_{cmd}^{mod} = {\vec{v}}_{cmd}^{nom} - {k}_{avoid} ( {\vec{v}}_{cmd}^{nom} \cdot {\vec{r}}_{o}^{meas} ) {\hat{e}}_{o} , where \text{:} \\ {k}_{avoid} = - min \{ 1 , {ⅇ}^{- ‖ {\vec{r}}_{o}^{meas} ‖ + {r}_{cr} {+}_{avoid}} \} ;$$

$${r}_{cr} = \frac{{( \vec{v} \cdot {\hat{e}}_{o} )}^{2}}{2 {a}_{max}} or {r}_{cr} = \frac{{( {\vec{v}}_{cmd}^{nom} \cdot {\hat{e}}_{o} )}^{2}}{2 {A}_{max}} ; and \\ {\hat{e}}_{ο} = \frac{{\vec{r}}_{o}^{meas}}{‖ {\vec{r}}_{o}^{meas} ‖} .$$

In these equations, the \vec{ν}_{cmd}^{mod} vector represents the vehicle's modified commanded velocity, the k_{avoid} term represents a gain factor based on distance between the mobile vehicle 110 and the obstacle 150, and the êₒ term represents a unit vector in the direction of the obstacle 150. As illustrated in FIG. 2A, the \vec{r}ₒ^{meas} vector represents the distance and direction from the mobile vehicle 110 to the obstacle 150, as measured by the radar 130. Due to limitations inherent in the resolution capabilities of the radar 130, the \vec{r}ₒ^{meas} vector may differ slightly from the \vec{r}ₒ vector, representing the actual distance and direction between the mobile vehicle 110 and the obstacle 150, as shown in the figure.

In general, a primary purpose of velocity command modification is to subtract from the vehicle's nominal commanded velocity the component that is in the direction of the obstacle 150. Thus, as the mobile vehicle 110 approaches an obstacle 150, it typically slows down and adjusts its trajectory such that it is moving away from the obstacle 150. The magnitude of the velocity modification increases as the distance between the mobile vehicle 110 and the obstacle 150 decreases. For example, as illustrated in FIG. 2B, the k_{avoid} gain factor varies between zero and one and increases as the mobile vehicle 110 comes nearer to the obstacle 150. In the illustrated embodiment, the k_{avoid} term is less than unity when the obstacle is farther than r_{cr}+r_{avoid}, and unity when closer. The r_{avoid} term represents a preferred minimum distance from the obstacle 150 determined, for example, from the navigation envelope of the mobile vehicle 110. The r_{cr} term represents a critical distance beyond which the mobile vehicle 110 cannot decelerate fast enough to avoid colliding with the obstacle 150.

In some embodiments, the relationship between the vehicle's actual commanded velocity, \vec{ν}_{cmd}, and the modified commanded velocity, \vec{ν}_{cmd}^{mod}, is set forth in the following equation:
\vec{ν}_{cmd}=\vec{ν}_{cmd}^{mod}+\vec{ν}_{c}.

The \vec{ν}_{c} term in this equation represents a velocity augmentation component that can be used for several different purposes. For example, the \vec{ν}_{c} term can be used to ensure that the \vec{ν}_{cmd} term does not remain zero. In addition, the \vec{ν}_{c} term can be used to impose certain characteristics on the trajectory of the mobile vehicle 110, thereby enabling the collision avoidance module 140 to implement a variety of collision avoidance strategies.

For example, in some embodiments, a random command addition strategy is implemented in which the \vec{ν}_{c} vector is pointed in a random direction. In these embodiments, the \vec{ν}_{c} term is added to the \vec{ν}_{cmd}^{mod} term only when the magnitude of the \vec{ν}_{cmd}^{mod} term is less than a selected minimum threshold velocity, νₘᵢₙ. Using this collision avoidance strategy, the \vec{ν}_{c} term is defined by the following equation:

$${\vec{v}}_{c} = {v}_{mag} [ \begin{matrix}{n}_{1} \\ {n}_{2}\end{matrix} ] .$$

In this equation,

$${v}_{mag} < {v}_{max} and [ \begin{matrix}{n}_{1} \\ {n}_{2}\end{matrix} ]$$

is a unit vector of random orientation in the x-y plane. Because the random command addition is not made until the mobile vehicle 110 gets close to an obstacle 150, this collision avoidance strategy results in minimal variation from the nominal straight-line trajectory generated by the vehicle's navigation system while it moves through a field of point obstacles. Therefore, this collision avoidance strategy is well-suited for point obstacles, or obstacles that are small compared to the radar cone (e.g., most trees and pillars).

In other embodiments, a systematic turn command addition strategy is implemented in which the mobile vehicle 110 systematically adjusts its trajectory by a selected offset angle when an obstacle 150 is encountered. In these embodiments, the \vec{ν}_{c} term is defined by the following equation:
\vec{ν}_{c}=ν_{mag}êₒ^{γ}.

In this equation, êₒ^{γ} is a unit vector obtained by rotating êₒ clockwise through the angle γ>θ in the x-y plane, as set forth in the following equation:

$${\hat{e}}_{o}^{γ} = [ \begin{matrix}cos γ & sin γ \\ - sin γ & cos γ\end{matrix} ] {\hat{e}}_{o} .$$

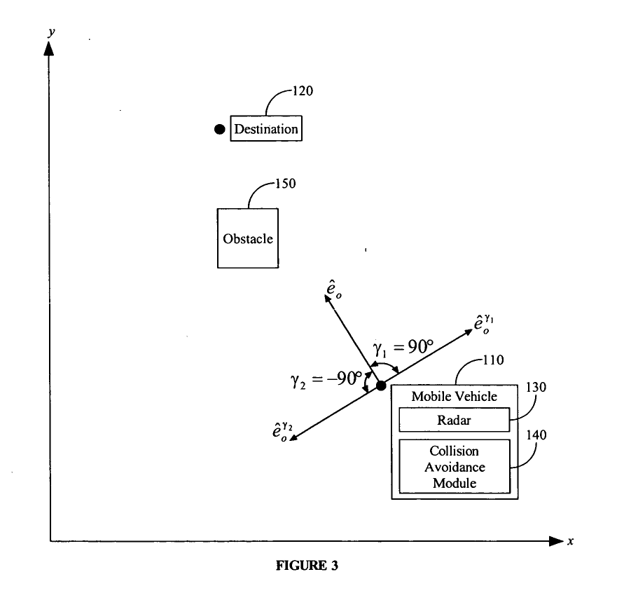

FIG. 3 illustrates a first exemplary embodiment in which γ=90° and a second exemplary embodiment in which γ=−90°. In these exemplary embodiments, the mobile vehicle 110 systematically turns right or left when an obstacle 150 is detected, and moves in a direction perpendicular to the obstacle 150 until the obstacle 150 is cleared. This collision avoidance strategy is well-suited for avoidance of larger obstacles, such as walls.

If the mobile vehicle 110 is traveling through an environment with numerous obstacles 150 and always turns the same direction when obstacles 150 are encountered, there may be a significant deviation from the nominal straight-line trajectory generated by the vehicle's navigation system. Accordingly, in some embodiments, it may be desirable to alternate between right-turn and left-turn collision avoidance strategies after each obstacle 150 is cleared.

In some embodiments, a fail-safe collision avoidance strategy is implemented in which the mobile vehicle 110 decelerates to a stop once an obstacle 150 is in sight and within critical range. The mobile vehicle 110 then moves in a perpendicular direction, as in the exemplary embodiments described above, using full control authority until the obstacle 150 is cleared.

If the mobile vehicle 110 is free to travel in three dimensions, then various other collision avoidance strategies are available. For example, in some embodiments, a three-dimensional systematic turn command addition strategy is implemented, which is similar to the two-dimensional turn strategy described above, but the êₒ^{γ} unit vector is obtained by rotating êₒ through the angle γ>θ in three-dimensional space. In these embodiments, the relationship between the êₒ^{γ} and êₒ unit vectors is governed by the following equation:
êₒ^{γ}·ê=cos γ.

The êₒ^{γ} unit vector can be selected to optimize some function of its components. For example, if êₒ^{γ} is chosen to maximize the z-component of the vector, it can be expressed as follows:

$${\hat{e}}_{ο}^{γ} = [ \begin{matrix}\frac{∓ {e}_{ox} {e}_{oz} sin γ + {e}_{ox} cos γ \sqrt{1 - {e}_{o z}^{2}}}{\sqrt{1 - {e}_{o z}^{2}}} \\ \frac{∓ {e}_{oy} {e}_{o z} sin γ + {e}_{oy} cos γ \sqrt{1 - {e}_{o z}^{2}}}{\sqrt{1 - {e}_{o z}^{2}}} \\ \pm \sqrt{1 - {e}_{o z}^{2}} sin γ + {e}_{o z} cos γ\end{matrix} ] , when {e}_{o z} \neq 1.$$

In other embodiments, the êₒ^{γ} unit vector can be selected to obtain a clockwise or counterclockwise direction in a plane orthogonal to the vehicle's velocity. In these embodiments, the \vec{ν}_{c} term is defined by the following equation:

$$\begin{matrix}{\vec{v}}_{c} = {v}_{mag} {\hat{e}}_{o}^{γ , ⊥} , where \\ {\hat{e}}_{o}^{γ , ⊥} = \frac{{\hat{e}}_{o}^{γ} \times {\hat{e}}_{o}}{‖ {\hat{e}}_{o}^{γ} \times {\hat{e}}_{o} ‖} .\end{matrix}$$

In some embodiments, as a final resort to avoid collisions with obstacles 150 of finite height, a collision avoidance strategy can be implemented in which mobile vehicle 110 decelerates, hovers, and climbs over the obstacle 150. In these embodiments, while the obstacle 150 is in range, the \vec{ν}_{cmd} vector is reduced to zero in all three dimensions until the mobile vehicle 110 comes to a stop and hovers, i.e., until \vec{ν}=0_{3×1}. The collision avoidance module 140 then commands the mobile vehicle 110 to climb, i.e., \vec{ν}_{cmd}=ê_{z}, until the obstacle 150 is cleared. This method is suited to places in which obstacles are mostly of uniform height or all less than a certain small height, as in a small town or village.

In some embodiments, the previous two collision avoidance strategies can be combined such that the former strategy is followed when an obstacle 150 in range is relatively far away, i.e., when ∥\vec{r}ₒ^{meas}∥>r_{cr}+r_{avoid}, and the latter strategy is followed when the obstacle 150 is near, i.e., when ∥\vec{r}ₒ^{meas}∥≦r_{cr}+r_{avoid}. In other embodiments, the collision avoidance strategies described above can be combined, supplemented, and/or revised in numerous ways to optimize the overall performance of the collision avoidance module 140.

In some embodiments, the mobile vehicle 110 may encounter a moving obstacle 150, such as, for example, another vehicle. In these embodiments, the modified command velocity can be computed using the following equation:
\vec{ν}_{cmd}^{mod}=\vec{ν}_{cmd}^{nom}−k_{avoid}[(\vec{ν}_{cmd}^{nom}−\vec{ν}ₒ)·\vec{r}ₒ^{meas}]êₒ.

In this equation, the \vec{ν}ₒ vector is the velocity of the moving obstacle 150. As described above, a number of different command addition terms, \vec{ν}_{c}, can be added to the \vec{ν}_{cmd}^{mod} vector to implement a variety of collision avoidance strategies. In addition, if multiple mobile vehicles 110 are flying in formation, different vehicles can implement different collision avoidance strategies. For example, one half of the mobile vehicles 110 can turn right when an obstacle 150 is encountered, and the other half can turn left when an obstacle 150 is encountered.

In some embodiments, when a given mobile vehicle 110 learns about an unexpected obstacle 150 through its radar 130 and collision avoidance module 140, this information is stored for future use by the same or other mobile vehicles 110. In these embodiments, a dither can be included in the commanded velocity signal to enable mobile vehicles 110 to “learn” the details of a given obstacle field more quickly. Such a dither also advantageously increases the effective field of view and resolution of the radar 130. Using this approach over time, the maps upon which the navigation systems of the mobile vehicles 110 are based can become more detailed and accurate, thereby enabling the navigation systems to generate obstacle-free map-based trajectories more efficiently.

The systems and methods described above present a number of distinct advantages over conventional mobile vehicle systems. For example, one or more of the collision avoidance strategies described above can be implemented as an add-on on top of map-based trajectory generators to enable mobile vehicles to avoid small unmapped obstacles and to correct for map inaccuracies. The strategies can also be implemented as an add-on in vehicles flying in formation to avoid collisions between component vehicles.

The use of radar feedback in the systems and methods described above also leads to several advantages. For example, radar-based obstacle detection is more reliable than visual obstacle detection due to non-robustness of imaging to atmospheric conditions, such as dust, smoke, fog, clouds, and precipitation. In addition, vision-based obstacle detection systems have slow performance in general because image processing takes time. Because radar-based systems have better performance, they advantageously enable unmanned mobile vehicles to travel at relatively high speeds while reacting quickly enough to avoid unexpected obstacles.

Although this invention has been described in terms of certain preferred embodiments, other embodiments that are apparent to those of ordinary skill in the art, including embodiments that do not provide all of the features and advantages set forth herein, are also within the scope of this invention. Accordingly, the scope of the present invention is defined only by reference to the appended claims and equivalents thereof.

What is claimed is:

1. An unmanned mobile vehicle comprising:
a radar configured to detect obstacles in the path of the unmanned mobile vehicle; and
a collision avoidance module configured to enable the unmanned mobile vehicle to avoid unexpected obstacles by adjusting the trajectory and velocity of the unmanned mobile vehicle based on feedback received from the radar.

2. The unmanned mobile vehicle of claim 1, wherein the unmanned mobile vehicle comprises a hover-capable UAV, a fixed-wing UAV, a mobile ground vehicle, or a UUV.

3. The unmanned mobile vehicle of claim 1, further comprising a navigation system configured to generate map-based trajectories.

4. The unmanned mobile vehicle of claim 1, wherein the radar has a maximum range of about 50 feet or less.

5. The unmanned mobile vehicle of claim 1, wherein the radar has a view angle of about 40° or less with an angular resolution of about 40°.

6. The unmanned mobile vehicle of claim 1, wherein when an obstacle is detected by the radar, the collision avoidance module modifies the commanded velocity of the unmanned mobile vehicle by subtracting from the nominal commanded velocity the component that is in the direction of the obstacle.

7. The unmanned mobile vehicle of claim 6, wherein the magnitude of the commanded velocity modification increases as the distance between the unmanned mobile vehicle and the obstacle decreases.

8. The unmanned mobile vehicle of claim 6, wherein a dither is included in the commanded velocity of the unmanned mobile vehicle.

9. The unmanned mobile vehicle of claim 6, wherein when the commanded velocity of the unmanned mobile vehicle approaches zero, the collision avoidance module adds a velocity augmentation component to the commanded velocity.

10. The unmanned mobile vehicle of claim 9, wherein the velocity augmentation component comprises a vector pointed in a random direction.

11. The unmanned mobile vehicle of claim 9, wherein the velocity augmentation component comprises a vector pointed a direction perpendicular to the obstacle.

12. The unmanned mobile vehicle of claim 9, wherein when the unmanned mobile vehicle comes within a selected critical distance of the obstacle, the unmanned mobile vehicle is stopped, pointed in a direction perpendicular to the obstacle, and commanded to move in that direction until the obstacle is cleared.

13. A method for avoiding an obstacle in an unmanned mobile vehicle, the method comprising:
detecting the obstacle with a radar; and
while the obstacle is within radar range, eliminating the component of the vehicle's velocity that is in the direction of the obstacle.

14. The method of claim 13, wherein the unmanned mobile vehicle comprises a hover-capable UAV, a fixed-wing UAV, a mobile ground vehicle, or a UUV.

15. The method of claim 13, wherein the radar has a maximum range of about 50 feet or less.

16. The method of claim 13, wherein the radar has a view angle of about 40° or less with an angular resolution of about 40°.

17. The method of claim 13, wherein when the commanded velocity of the unmanned mobile vehicle approaches zero, a velocity control component is added to the commanded velocity.

18. The method of claim 17, wherein the velocity control component comprises a vector pointed in a random direction.

19. The method of claim 17, wherein the velocity control component comprises a vector pointed a direction perpendicular to the obstacle.

20. The method of claim 17, wherein when the unmanned mobile vehicle comes within a selected critical distance of the obstacle, the unmanned mobile vehicle is stopped, pointed in a direction perpendicular to the obstacle, and commanded to move in that direction until the obstacle is cleared.

21. A system comprising a plurality of unmanned mobile vehicles, wherein each unmanned mobile vehicle comprises:
a navigation system configured to generate map-based trajectories;
a radar configured to detect obstacles in the path of the unmanned mobile vehicle; and
a collision avoidance module configured to enable the unmanned mobile vehicle to avoid unexpected obstacles by adjusting the trajectory and velocity of the unmanned mobile vehicle based on feedback received from the radar.

22. The system of claim 21, wherein the unmanned mobile vehicles are selected from the group consisting of hover-capable UAVs, fixed-wing UAVs, mobile ground vehicles, and UUVs.

23. The system of claim 21, wherein information learned via the traversal of a given obstacle field by an unmanned mobile vehicle is subsequently used to improve the performance of the navigation systems of one or more unmanned mobile vehicles traversing the same obstacle field.

24. The system of claim 21, wherein when a group of unmanned mobile vehicles are traveling in formation, a first collision avoidance strategy is implemented in a first subgroup of the unmanned mobile vehicles and a second collision avoidance strategy is implemented in a second subgroup of the unmanned mobile vehicles.

25. The system of claim 24, wherein the first collision avoidance strategy comprises a turn-right collision avoidance strategy and the second collision avoidance strategy comprises a turn-left collision avoidance strategy.
